(19) United States
(12) Patent Application Publication
(10) Pub. No.: US 2006/0073841 A1
(43) Pub. Date: Apr. 6, 2006

(54) Method and communication system for establishing a voice call connection

(76) Inventors: Murali Narasimha, Grayslake, IL (US); Joseph R. Schumacher, Glen Ellyn, IL (US)

Correspondence Address: MOTOROLA INC, 600 NORTH US HIGHWAY 45, ROOM AS437, LIBERTYVILLE, IL, 60048-5343, US

(21) Appl. No.: 10/956,659

(22) Filed: Oct. 1, 2004

(51) Int. Cl. H04Q 7/20

(52) U.S. Cl. 455/458; 455/445

(57) ABSTRACT

A communication system and method for establishing a voice call connection with a wireless communication device is provided. The communication system includes a first network, which supports circuit switched voice call connections, a second network, which supports data packet voice call connections, and one or more wireless communication devices. The first network transmits a received paging request to a corresponding wireless communication device, and if a packet data connection already exists between the second network and the corresponding wireless communication device, then the second network transmits an incoming circuit call indication, based upon a received paging request, to the corresponding wireless communication device.

### FIELD OF THE INVENTION

The present invention relates generally to establishing a voice call connection in a wireless communication device, such as a radio telephone. More particularly, the present invention relates to establishing a voice call connection via a packet data network, when an already established connection to the packet data network exists.

### BACKGROUND OF THE INVENTION

Cellular telephones have historically been principally used to support circuit switched voice calls. However, increasingly cellular telephones are being used to support data communications, as cellular phones are updated to incorporate additional types of communication related functionality. For example, cellular telephones are increasingly supporting functions associated with data communications, such as text messaging, email, and web browsing. Many of these data type communications make use of packet data networks. Furthermore, as the non-communication centric related functionalities of the cellular telephone is similarly enhanced, still greater opportunities exist to convey data through the over the air network connections. One such example includes the ability to take pictures, which can then be transmitted to other devices and/or individuals via an over the air network connection. Another example includes the ability to use the cellular telephone as a modem to connect a computer to the Internet.

However many wireless communication devices do not support concurrent voice and data communications. Even in instances where a phone is not actively engaged in a voice communication, but is presently supporting a packet data communication, many wireless communication devices will periodically interrupt an existing data communication in order to check for incoming calls. Still further, when an incoming call is detected, many wireless communication devices will suspend the data communication until the voice call is completed.

In at least one example, circuit switched voice communications may be supported through a TIA-2000 or a 1×RTT network, while packet data communications may be supported by an HRPD or a 1×EV-DO network. The concurrent handling of circuit switched communications and packet data communications is at least partially problematic, because the corresponding networks supporting the respective communications are often deployed using different RF frequencies. Still further the different networks will employ different communication protocols, as well as different signaling schemes. This can result in the voice and data streams needing to be separately conveyed to the wireless communication device.

Support for voice communications via the packet data networks has been developed. One such example includes a protocol referred to as voice over Internet protocol (VoIP). Voice communications via a packet data network connection under the right circumstances could presumably enable the concurrent support of voice and packet data communications. However, operators are not yet ready to shift or switch all of their supported voice communications to the packet data networks. There continues to be a preference to support voice call communications via the circuit switched network, in absence of sufficient countervailing considerations.

Nevertheless, the present inventors have recognized that support for voice communications via the packet data network may be beneficial, in instances where there is an existing packet data communication connection. Consequently, the inventors have further recognized a benefit associated with methods for establishing a voice call communication, which can alternatively use either a circuit switched communication connection or a packet data communication connection, depending upon other communication considerations and conditions.

### SUMMARY OF THE INVENTION

The present invention provides for a method for establishing a voice call connection in a wireless communication device. The method includes receiving a paging request for a voice call connection at a home network of a subscriber, and forwarding the paging request to a visited network in which the wireless communication device is presently located. The paging request is transmitted to the wireless communication device by the visited network via the circuit switched network. A determination is then made by the visited network as to whether the wireless communication device has an already established connection to a packet data network. If so, an incoming circuit call indication is transmitted to the wireless communication device by the visited network via the already established connection to the packet data network.

In at least one embodiment, a voice call connection is established via the circuit switched network, if the paging request for a voice call connection is received via the circuit switched network.

In at least a further embodiment, an invitation is sent from the wireless communication device to the home network, in order to establish a voice call connection via the packet data network, if the incoming circuit call indication for a voice call connection is received via the already established connection to the packet data network.

The present invention further provides a method for receiving a paging request for a voice call communication in a wireless communication device. The method includes determining if a packet data network connection for use by the wireless communication device presently exists. If a packet data network connection exists, then receiving incoming circuit call indications for a voice call connection via the packet data network connection. If a packet data network connection does not exist, then the circuit switched network is monitored for paging requests for a voice call connection.

The present invention still further provides a wireless communication device for establishing a voice call connection, which includes a transceiver adapted for establishing a connection with each of a circuit switched network and a packet data network, and a controller. The controller includes a determination module for determining if a packet data network connection for use by the wireless communication device presently exists, a reception module for receiving incoming circuit call indications for a voice call connection via the packet data network connection, if a packet data network connection does presently exist, and a detection module for monitoring a circuit switched network for a paging request for a voice call connection, if a packet data network connection does not presently exist.

Further yet, the present invention provides for a communication system for establishing a voice call connection with a wireless communication device. The communication system includes a first network, which supports circuit switched voice call connections, a second network, which supports packet data voice call connections, and one or more wireless communication devices. The first network transmits a received paging request to a corresponding wireless communication device, and if a packet data connection already exists between the second network and the corresponding wireless communication device, then the second network transmits an incoming circuit call indication, based upon a received paging request, to the corresponding wireless communication device.

These and other features, and advantages of this invention are evident from the following description of one or more preferred embodiments of this invention, with reference to the accompanying drawings.

### BRIEF DESCRIPTION OF THE FIGURES

The present invention will be described by way of exemplary embodiments, but not limitations, illustrated in the accompanying drawings in which like references denote similar elements, and in which:

FIG. 1 is a block diagram of an exemplary communication system illustrating an environment within which at least one embodiment of the present invention can operate;

FIG. 2 is a more detailed block diagram of the exemplary communication system illustrated in FIG. 1;

FIG. 3 is an information flow diagram of a method for establishing a voice call connection in accordance with at least one embodiment of the present invention;

FIG. 4 is a block diagram of a wireless communication system, within which a voice call connection can be established in accordance with at least one embodiment of the present invention;

FIG. 5 is a flow diagram of a method for establishing a voice call connection in a wireless communication device, in accordance with at least one embodiment of the present invention;

FIG. 6 is a flow diagram of a method for receiving an indication of an incoming circuit call;

FIG. 7 is a flow diagram of a method of responding to an incoming circuit call indication; and

FIG. 8 is a flow diagram of a method for establishing a circuit call connection in response to an invitation to establish a voice call connection.

### DETAILED DESCRIPTION

As required, detailed embodiments of the present invention are disclosed herein, however, it is to be understood that the disclosed embodiments are merely exemplary of the invention, which can be embodied in various forms. Therefore, specific structural and functional details disclosed herein are not to be interpreted as limiting, but merely serve as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

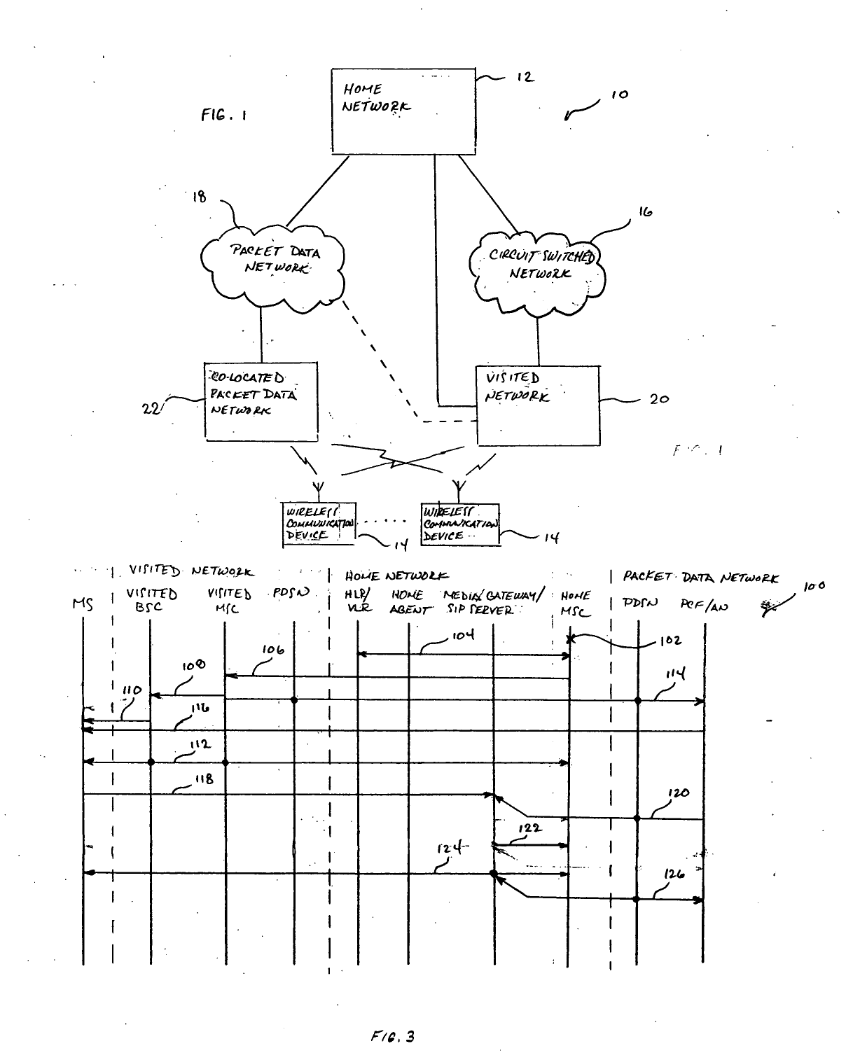

FIG. 1 is a block diagram of an exemplary communication system 10 illustrating an environment within which one or more embodiments of the present invention can operate. The communication system includes a home network 12, which serves as a home base or host for one or more wireless communication devices 14. The home network 12 in at least some instances will maintain registry and location information, which enables incoming calls and/or outgoing calls corresponding to an associated wireless communication device to be properly routed.

In at least some instances a home network 12 will have an associated geographical area. As a wireless communication device 14 moves between the geographical area associated with the home network 12 and other geographical areas associated with other networks or portions of a network, the registry information relative to the wireless communication device 14 maintained in the home network 12 is updated so as to enable the communications relative to present and future call connections to be properly routed.

The communication system 10 further includes a circuit switched network 16, which can include circuit elements that support one or more circuit switched connections. One such example of a network, which can form all or parts of the illustrated circuit switched network 16 includes a public switched telephone network. Other examples can include further wireless communication networks and/or portions, thereof, and/or various combinations of wired and wireless network elements to the extent that they can support circuit switched connections. The circuit switched network 16 is communicatively coupled to home network 12.

Additionally coupled to the home network 12 is a packet data network 18, where the packet data network 18 generally supports packet data communications. An example of a well known packet data network 18 includes the Internet. One skilled in the art will be well aware of additional other types and/or forms of packet data networks, which in addition to the Internet, are suitable for forming all or parts of the packet data network 18.

The communication system 10 additionally includes a visited network 20, which can be coupled either directly to the home network 12, or coupled indirectly to the home network 12, for example via the circuit switched network 16. In at least the illustrated embodiment, the visited network 20 provides an area of communication coverage within which at least one of the wireless communication devices 14, that is associated with the home network 12, is presently located. The communication system 10 still further includes a packet data network portion 22, which has a coverage area, which is at least partially co-located with the coverage area of visited network 20, and which similarly includes the present location of the at least one of the wireless communication devices 14.

Generally, the visited network 20 includes infrastructure elements, such as radio access network elements, via which a circuit switch connection can be established with the at least one wireless communication device 14, which is present within the geographical coverage area, assuming that the wireless communication device 14 suitably support corresponding circuit switched connections. Similarly, the at least partially co-located packet data network 22 includes infrastructure elements via which a packet data connection can be established with the at least one wireless communication device 14, again assuming that the wireless communication device 14 suitably supports corresponding packet data connections. Optionally, the visited network 20 can also support some form of packet data communications, for example as specified in the Telecommunications Industry Association's TIA-2000 and TIA-707, and correspondingly may also be more directly communicatively coupled to the packet data network 18.

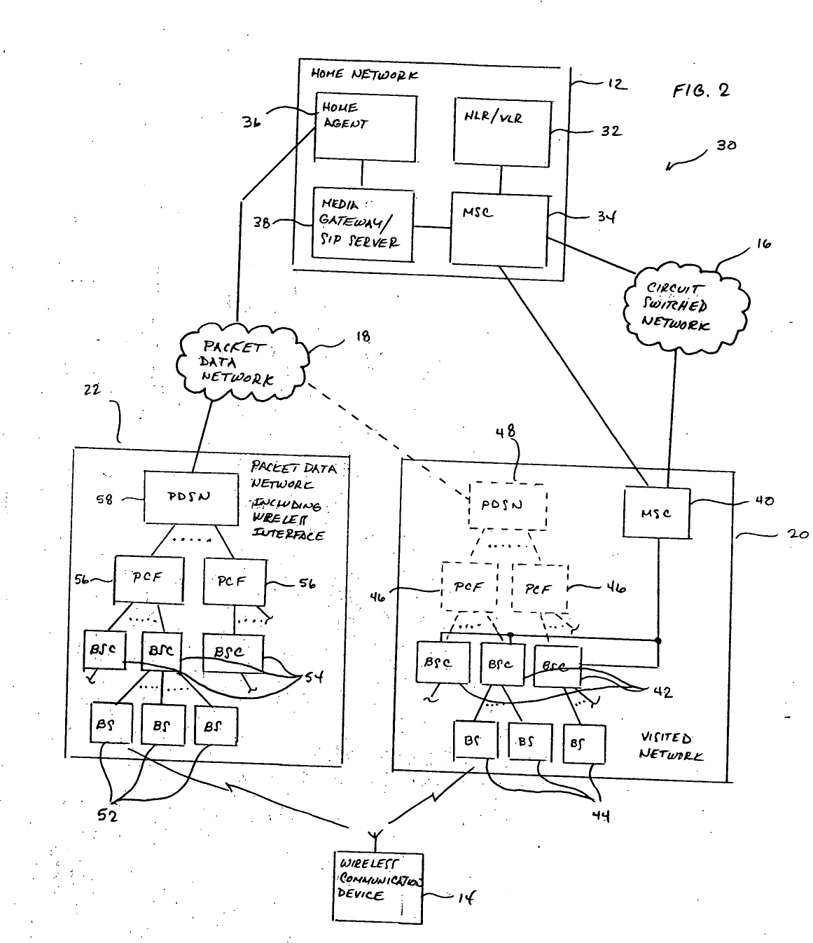

FIG. 2 is a more detailed block diagram 30 of the exemplary communication system 10 illustrated in FIG. 1. The more detailed block diagram 30 includes additional details relative to exemplary embodiments of the home network 12, the visited network 20, and the packet data network 22. As further illustrated, the home network 12 includes a home location register (HLR)/visitor location register (VLR) 32, which includes information corresponding to the one or more assigned wireless communication devices 14. Examples of information maintained and supported by an HLR/VLR includes profile information and current location within the network, concerning one or more associated wireless communication devices, as well as information concerning the handling of calls to and from visiting wireless communication devices 14, relative to at least a circuit switched communication connection. The home network 12 additionally includes a mobile switching center (MSC) 34, which facilitates the routing of information via a circuit switched call connection, and the establishment of the same.

The home network, illustrated in FIG. 2, additionally includes a home agent 36, which performs a role similar to the HLR relative to packet data communication connections; and a media gateway/session initiation protocol (SIP) server 38, which facilitates the initiation of a data connection session, as well as facilitates the conversion of relayed information between media formats consistent with cellular services.

The visited network 20, similar to the home network 12, includes a mobile switching center (MSC) 40, which is shown coupled to each of the circuit switched network 16, and the MSC 34 of the home network. The MSC 40 similarly facilitates the routing and the establishment of circuit switched call connections within the circuit switched network 16. The MSC 40 is coupled to one or more base station controllers 42, each of which is coupled to one or more base stations (BS) 44, which are each responsible for communicating with wireless communication devices 14, that are present in corresponding geographical areas associated with each of the base stations 44.

As noted previously, the visited network 20 optionally supports packet data connections between the at least one wireless communication device 14 and the packet data network 18. In support of such a connection, the visited network 20, optionally includes one or more packet control functions (PCF) 46, which are coupled to the BSC's 42, and a packet data service node (PDSN) 48, which functions as a router for the data communicated between the packet data network 18 and the visited network 20. The illustrated visited network, including the optional elements supporting packet data connections, is representative of at least some embodiments of a 1×RTT network, as well as at least some networks compatible with the Telecommunications Industry Association TIA-2000 specification.

The packet data network 22, with the exception of the MSC 40, similarly includes the one or more base stations (BS) 52, one or more base station controllers (BSC) 54, one or more packet control functions (PCF) 56, and a packet data service node (PDSN) 58. At least some embodiments of the packet data network 22, for example a high rate packet data (HRPD) network, might combine the BS with the BSC into one element called an access node (AN). By including a packet data network 22 separate from the visited network 20, the elements forming the packet data network 22 can be optimized for packet data throughput, and therefore may provide for additional data throughput, which may not be readily achievable by packet data communications support elements incorporated as part of the visited network 20, which has the additional task of supporting circuit switched communication connections. Still further, the packet data network 22 could be configured to make use of an alternative set of frequencies, which while increasing the overall number of channels that are available for handling communications, may make it difficult for a wireless communication device 14 to support concurrent communications via each of the packet data network 22 and the visited network 20. The illustrated packet data network 22, is representative of at least some embodiments of a high rate packet data network, such as a 1×EV-DO and/or an HRPD network.

In at least some embodiments of the present invention, voice calls, which have traditionally been established via a circuit switched communication connection, are established via a packet data connection, when an existing packet data connection is already established. Such a connection can allow for the data associated with the voice communications to be packetized and conveyed concurrently with other packetized data flows. This allows for a voice communication to be supported without having to suspend any of the existing data flows. At least one technique which supports voice communications via a packet data connection includes voice over Internet protocol (VoIP).

In addition to allowing for multiple concurrent data streams in addition to the data stream associated with the voice communication, conveyance of an incoming circuit call indication via the packet data communication connection, allows the wireless communication device to receive notifications of incoming circuit switched calls without monitoring the circuit switched network. More specifically, this allows the overhead associated with periodically monitoring an alternative communication network, such as the visited network 20, to be avoided. If no such already established packet data connection exists via the packet data network 22, then the wireless communication device 14 may monitor the paging channels of the visited network 20 for any paging alerts, which signify an incoming call via the circuit switched network 16. When an incoming voice call is detected, in absence of an existing packet data connection, the voice call connection can be established, via the circuit switched network 16.

FIG. 3 is an information flow diagram 100 of a method for establishing a voice call connection in accordance with at least one embodiment of the present invention. The flow diagram includes an initial detection 102 of an incoming circuit switched call for a wireless communication device 14, such as a mobile subscriber (MS) at the home MSC 34. The home MSC 34, then queries 104 the HLR/VLR 32 as to the present location of the target wireless communication device 14. A paging request is then forwarded 106 to the MSC 40 in the visited network 20. The visited MSC 40 then further forwards 108 the paging request to the BSC 42 of the visited network 20, which in turn transmits 110 the paging request to the wireless communication device 14 via the visited network 20.

If the wireless communication device 14 receives the paging request, via the visited network 20, a voice call connection is established 112, via a circuit switched connection. As noted previously, in at least some embodiments, the wireless communication device 14 will only monitor the circuit switched network 16, and correspondingly a communication from the visited network 20, for an indication of an incoming call, if the wireless communication device 14 does not already have an established connection to the packet data network 22. In instances where an already established connection to the packet data network 22 exists, even though a paging request is transmitted by the visited network 20, the paging request will not be received, as the wireless communication device 14 is not configured to receive such a communication, i.e. the wireless communication device 14 is actively involved in data transfer via the radio access network elements of the packet data network 22 and is not monitoring the circuit switched radio access network elements of the visited network 20.

If an already established connection to a packet data network is determined to exist, the visited MSC 40 (or in some instances the visited BSC 42) will additionally forward 114 the paging request to the PCF 56 of the packet data network 22. In at least one embodiment, where the visited network 20 supports a direct connection to the packet data network 18, via a PDSN 48 and PCF 46, the paging request is forwarded 114 to the PCF 56 via the PDSN 48 of the visited network 20, the packet data network 18, and the PDSN 58 of the packet data network 22. Upon receipt of the paging request by the PCF 56 of the packet data network 22, the packet data network 22 formulates and transmits 116 an incoming circuit call indication to the wireless communication device 14.

The wireless communication device 14, upon receipt of the incoming circuit call indication, sends 118 a SIP invitation to the media gateway/SIP server 38 of the home network 12, via 120 the packet data network 22 and 18, to establish a voice call connection, via the already established and/or an upgraded connection to the packet data network. The media gateway/SIP server 38 then conveys a call indication 122 to the home MSC 34. The media gateway/SIP server 38, if appropriate, can translate the invitation between a form supported by the packet data network 18 and a form supported by the circuit switched network 16.

The home MSC 34 then checks, if there is an outstanding page request for the wireless subscriber unit 14 that sent the SIP invitation. If an outstanding page request exists, then the home MSC 34 connects 124 the existing circuit corresponding to the outstanding page request through the media gateway/SIP server 38 as a VoIP call, via 126 the packet data network 22 and 18. If no such outstanding page request exists, the home MSC 34, treats the request as a request to establish a circuit for a new call.

In order to facilitate a determination as to whether an outstanding page request exists, in at least one embodiment, the SIP invitation can include the identification of the originating entity of the incoming circuit switched call. The identification of the originating entity of the incoming circuit switched call, would similarly need to have been conveyed and preserved as part of all of the related prior sequential communications in order for the information to be available to the wireless communication device 14.

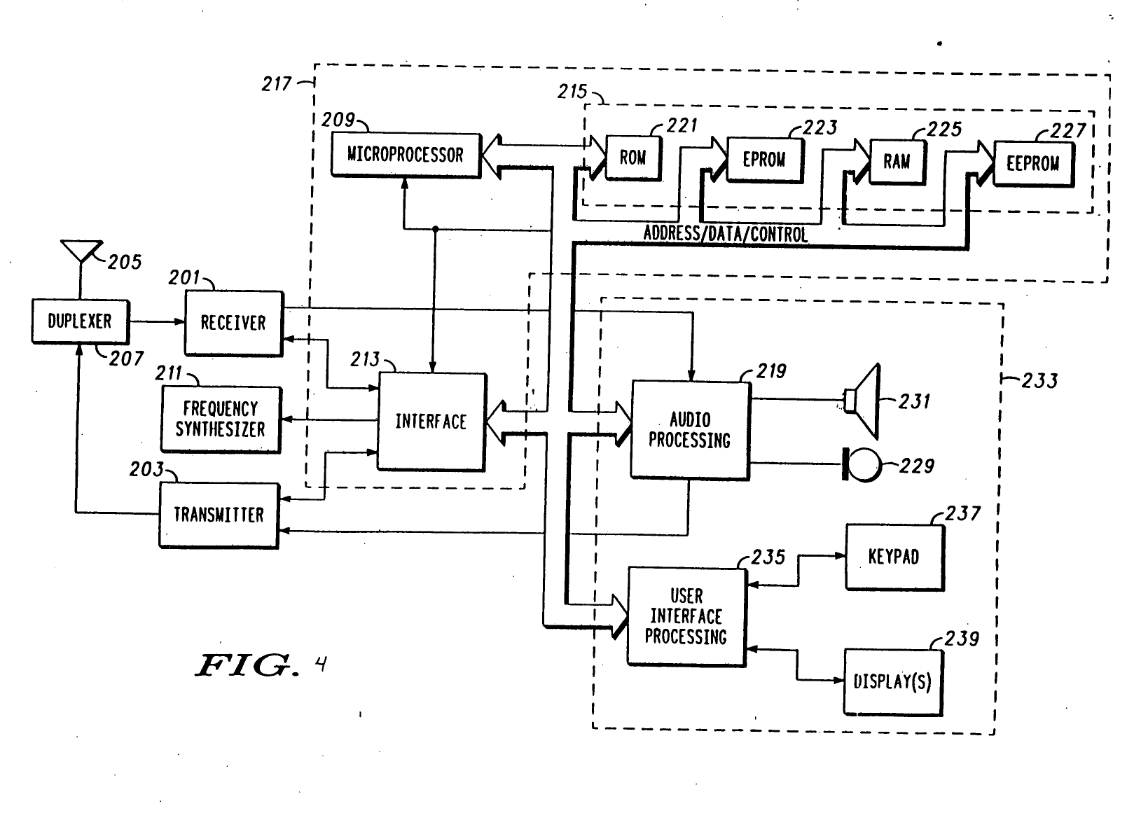

In at least one embodiment, portions of the present invention are implemented as part of and/or are performed in conjunction with a wireless communication device. FIG. 4 illustrates at least one exemplary embodiment of a wireless communication device 200, such as a radio telephone, which could be used to incorporate the present invention. The wireless communication device 200 includes a radio receiver 201 and a transmitter 203. Both the receiver 201 and the transmitter 203 are coupled to an antenna 205 of the wireless communication device by way of a duplexer 207. The particular radio frequency to be used by the transmitter 203 and the receiver 201 is determined by the microprocessor 209 and conveyed to the frequency synthesizer 211 via the interface circuitry 213. Data signals received by the receiver 201 are decoded and coupled to the microprocessor 209 by the interface circuitry 213, and data signals to be transmitted by the transmitter 203 are generated by the microprocessor 209 and formatted by the interface circuitry 213 before being transmitted by the transmitter 203. Operational status of the transmitter 203 and the receiver 201 is enabled or disabled by the interface circuitry 213.

In the preferred embodiment, the microprocessor 209 forms part of the processing unit, which in conjunction with the interface circuitry 213 performs the necessary processing functions under the control of program instructions stored in a memory section 215. Together, the microprocessor 209 and the interface circuitry 213 can include one or more microprocessors, one or more of which may include a digital signal processor (DSP). The memory section 215 includes one or more forms of volatile and/or non-volatile memory including conventional read only memory (ROM) 221, erasable programmable read only memory (EPROM) 223, random access memory (RAM) 225, or electrically erasable programmable read only memory (EEPROM) 227. Identifying features of the wireless communication device are typically stored in EEPROM 227 (which may also be stored in the microprocessor in an on-board EEPROM, if available) and can include the number assignment (NAM) required for operation in a conventional cellular system. Additionally stored in the memory section 215 are prestored instructions for establishing and maintaining call connection, such as voice call connections including determinations as to whether communication connections to available networks already exist, and the receipt and handling of incoming call indications. In at least some instances the above noted functions associated with prestored instructions can partially and/or alternatively make use of hardware elements, such as logic gates, registers, and/or other interface and control circuitry, which in turn interact with the other elements of the wireless communication device.

Control of user audio, the microphone 229 and the speaker 231, is controlled by audio processing circuitry 219, which forms part of a user interface circuit 233. The user interface circuit 233 additionally includes user interface processing circuitry 235, which manages the operation of any keypad(s) 237 and/or display(s) 239. It is further envisioned that any keypad operation could be included as part of a touch sensitive display.

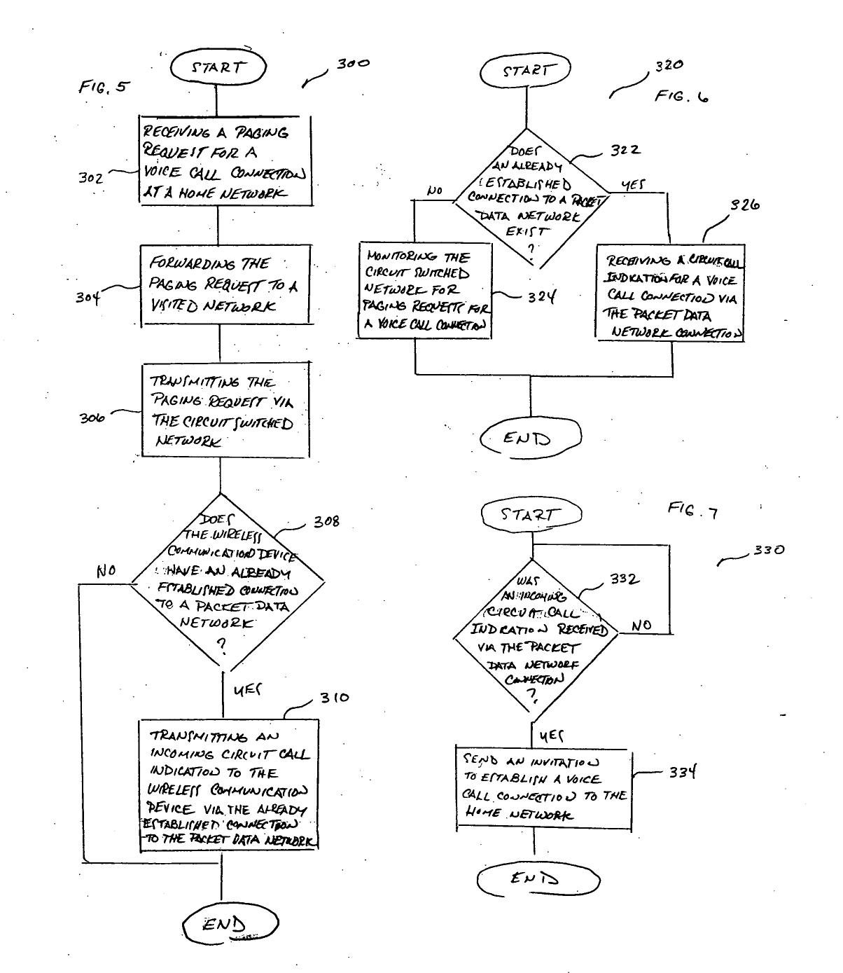

FIG. 5 illustrates a flow diagram 300 of a method for establishing a voice call connection in a wireless communication device, in accordance with at least one embodiment of the present invention. The method includes receiving 302 a paging request for a voice call connection at a home network 12. The paging request is then forwarded 304 to a visited network 20. The paging request is then transmitted 306, via the circuit switched network 16. A determination 308 is then made, as to whether the wireless communication device 14 has an already established connection to a packet data network 18. If an already established packet data network connection is determined to exist, then an incoming circuit call indication is transmitted 310 to the wireless communication device 14, via the already established connection to the packet data network.

In accordance with at least some embodiments, if the paging request is received by the wireless communication 14 via the circuit switched network 16, a voice call connection is established via the circuit switched network 16.

FIG. 6 illustrates a flow diagram 320 of a method for receiving an indication of an incoming circuit call by the wireless communication device 14. The wireless communication device 14, in response to a determination 322 as to whether an already established connection to the packet data network 18 exists, monitors 324 the circuit switched network 16 for paging request for a voice call connection, if an already established connection to the packet data network 18 does not exist. If an already established connection to the packet data network 18 does exist, then the wireless communication device 14 receives 326 incoming circuit call indications for a voice call connection, via the packet data network connection.

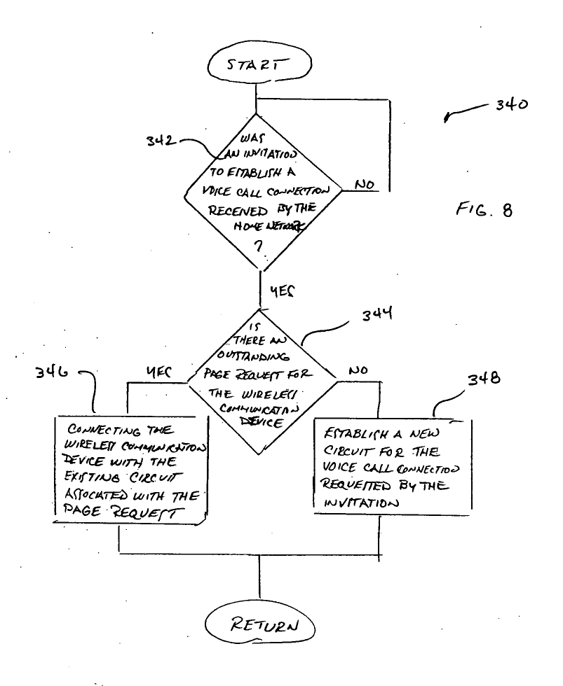

FIG. 7 illustrates a flow diagram 330 of a method of responding to an incoming circuit call indication. If an incoming circuit call indication is determined 332 to have been received by the wireless communication device 14, via the packet data network connection, then an invitation to establish a voice call connection to the home network 12 is sent 334.

FIG. 8 illustrates a flow diagram 340 of a method for establishing a circuit call connection in response to an invitation to establish a voice call connection. If an invitation to establish a voice call is determined 342 to have been received by the home network 12, then a determination 344 is made as to whether there is a corresponding outstanding page request for a requested voice call connection for the wireless communication device 14 sending the invitation. If a relevant outstanding page request exists, then the wireless communication device 14 is connected 346, via a voice call connection over the packet data network, such as a VoIP connection, with the existing circuit associated with the paging request. If a relevant outstanding page request does not exist, then a circuit connection associated with a new voice call over the packet data network is established 348.

While the present invention has generally been described in association with a wireless communication device, like a radio telephone, a cell phone or a cordless telephone, one skilled in the art will readily recognize that the invention is suitable for use with other types of devices. At least a couple of additional examples of other types of devices, where the use of the present invention would be suitable include paging devices, personal digital assistants, portable computers, pen-based or keyboard-based handheld devices, remote control units, an audio player (such as an MP3 player) and the like to the extent that they might be capable of supporting both circuit switched and packet data connections. Still further, while the circuit switched connection is often referred to as a voice call connection, one skilled in the art will readily appreciate that the voice call connection in addition and or alternative to voice type data could additionally support non-voice type data. Examples of non-voice type data, which is frequently communicated via voice call connections includes facsimile transmissions and dial-up modem data communication connections.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A method for establishing a voice call connection in a wireless communication device, the method comprising:
receiving a paging request for a voice call connection at a home network of a subscriber;
forwarding the paging request to a visited network in which the wireless communication device is presently located;
transmitting the paging request to the wireless communication device by the visited network via the circuit switched network; and
determining by the visited network if the wireless communication device has an already established connection to a packet data network, and, if so, transmitting an incoming circuit call indication to the wireless communication device by the visited network via the already established connection to the packet data network.

2. A method in accordance with claim 1 further comprising establishing a voice call connection via the circuit switched network, if the paging request for a voice call connection is received via the circuit switched network.

3. A method in accordance with claim 1 further comprising sending an invitation from the wireless communication device to establish a voice call connection via the packet data network to the home network, if the incoming circuit call indication for a voice call connection is received via the already established connection to the packet data network.

4. A method in accordance with claim 3 wherein sending an invitation to establish a voice call connection via the packet data network to the home network includes translating the invitation between a form supported by the packet data network and a form supported by the circuit switched network.

5. A method in accordance with claim 3 wherein the incoming circuit call indication includes an identity of a calling party initiating the paging request.

6. A method in accordance with claim 5 wherein the invitation includes a target address, which corresponds to the identity of the calling party.

7. A method in accordance with claim 3 further comprising, upon receipt of an invitation to establish a voice call, determining if there is an outstanding paging request for the wireless communication device that sent the invitation, and if there is an outstanding paging request for the wireless communication device that sent the invitation, connecting the wireless communication device with the existing circuit associated with the requested voice call connection.

8. A method in accordance with claim 7 wherein if there is not an outstanding paging request for the wireless communication device that sent the invitation, establishing a circuit for a new voice call.

9. A method in accordance with claim 7 wherein the wireless communication device is connected with the existing circuit associated with the requested voice call connection via the packet data network.

10. A method in accordance with claim 9 wherein connecting the wireless communication device with the existing circuit associated with the requested voice call connection includes translating the call data communicated between the wireless communication device and the existing circuit between a form supported by the packet data network and a form supported by the circuit switched network.

11. A method in accordance with claim 7 wherein the requested voice call connection is supported concurrently with any already established connections to the packet data network.

12. A method for receiving a paging request for a voice call communication in a wireless communication device, the method comprising:
determining if a packet data network connection for use by the wireless communication device presently exists;
if so, receiving incoming circuit call indications for a voice call connection via the packet data network connection;
if not, monitoring the circuit switched network for paging requests for a voice call connection.

13. A method in accordance with claim 12 wherein when a voice call connection is established in response to an incoming circuit call indication for a voice call connection received via the packet data network, the voice call connection is concurrently established via the packet data network without suspending any ongoing data transmissions being communicated via the packet data network.

14. A method in accordance with claim 12 wherein, as the wireless communication device moves between paging zones, the wireless communication device updates the presence information of the wireless communication device at the home network of the wireless communication device.

15. A wireless communication device for establishing a voice call connection comprising:
a transceiver adapted for establishing a connection with each of a circuit switched network and a packet data network; and
a controller including
a determination module for determining if a packet data network connection for use by the wireless communication device presently exists,
a reception module for receiving incoming circuit call indications for a voice call connection via the packet data network connection, if a packet data network connection does presently exist, and
a detection module for monitoring a circuit switched network for a paging request for a voice call connection, if a packet data network connection does not presently exist.

16. A wireless communication device in accordance with claim 15 wherein the controller is adapted to support concurrent voice and data communications via a packet data network.

17. A wireless communication device in accordance with claim 15 wherein the wireless communication device is a radio telephone.

18. A wireless communication device in accordance with claim 15 wherein the circuit switched network will be monitored for paging requests for a voice call connection only if a packet data network connection for use by the wireless communication device is determined not to presently exist.

19. A communication system for establishing a voice call connection with a wireless communication device, the communication system comprising:
a first network, which supports circuit switched voice call connections;
a second network, which supports packet data voice call connections; and
one or more wireless communication devices;
wherein the first network transmits a received paging request to a corresponding wireless communication device, and if a packet data connection already exists between the second network and the corresponding wireless communication device, then the second network transmits an incoming circuit call indication, based upon a received paging request, to the corresponding wireless communication device.

20. A communication system in accordance with claim 19 further comprising a home network, which is adapted to receive an initial paging request and forwarding the received initial paging request to the first network and the second network.

21. A communication system in accordance with claim 20 wherein the home network is communicatively coupled to a publicly switched telephone network.

22. A communication system in accordance with claim 19 wherein the first network is a TIA-2000 network.

23. A communication system in accordance with claim 19 wherein the second network is a high rate packet data (HRPD) network.
